(19) United States
(12) Patent Application Publication
(10) Pub. No.: US 2009/0136306 A1
(43) Pub. Date: May 28, 2009

(54) Planing Apparatus And Method

(76) Inventors: Russell J. Howard, Denham Springs, LA (US); Jeffrey A. Henderson, Livingston, LA (US)

Correspondence Address: McGLINCHEY STAFFORD, PLLC;Attn: IP Group, 301 Main Street, 14th Floor, BATON ROUGE, LA, 70802, US

(21) Appl. No.: 11/944,778

(22) Filed: Nov. 26, 2007

(51) Int. Cl. B23B 51/02; B23B 35/00

(52) U.S. Cl. 408/1 R; 408/82; 408/225

(57) ABSTRACT

A planing apparatus which has an elongated bladelike member having a thickness, a width and a length, which bladelike member is symmetrical about an imaginary central longitudinal axis, and which bladelike member comprises (i) a shoulder portion comprised of two beveled cutting areas and (ii) a body portion forming a leading edge which is convex relative to the body portion. The planing apparatus has an elongated shank member for coupling the planing apparatus to a rotational driver, which shank member is attached to and axially aligned with the shoulder portion of the bladelike member.

### FIELD OF THE INVENTION

The present invention relates to apparatus and methods for planing out unwanted sections of pipe materials.

### BACKGROUND

There is currently widespread use of polyvinyl chloride (PVC) pipe, heat resistant polyvinyl chloride (HPVC) pipe and corrosion resistant polyvinyl chloride (CPVC) pipe in the plumbing and building industries. A few of the desirable features of these piping materials relate to the ease of cutting of pipe segments and ease of attachment of the pipe segments to various fittings and couplings of the same type of material, using special glues and pipe cements. When mistakes are made in measurement or when breaks occur at or near junctions of pipe sections to fittings, the replacement process for multiple pieces of pipe and perhaps multiple fittings can be time-consuming and costly.

Therefore a need exists for a way to rework the existing pipe segments or fittings to permit reattachment and reuse of damaged or otherwise unsuitable materials.

### SUMMARY OF THE INVENTION

The present invention meets this need, amongst others, by providing apparatus and methods to quickly and economically rework and rehabilitate broken or otherwise unsuitable sections of fittings or pipe segments. Typically a section of PVC, CPVC or HPVC pipe will have broken, leaving part of the pipe section attached to the interior of a fitting or other pipe. An embodiment of the invention provides a planing apparatus comprising: A) an elongated bladelike member having a thickness, a width and a length, which bladelike member is symmetrical about an imaginary central longitudinal axis, and which bladelike member comprises (i) a shoulder portion comprised of two beveled cutting areas and (ii) a body portion forming a leading edge which is convex relative to the body portion; and B) an elongated shank member for coupling the planing apparatus to a rotational driver, which shank member is attached to and axially aligned with the shoulder portion of the bladelike member.

In another embodiment of the invention each of the beveled cutting areas comprise two cutting edges which converge. In further embodiments of the invention, the two cutting edges converge to form an acute angle. The angle of incidence between a first cutting edge and a second cutting edge is measured to be in a range of from about 77 degrees to about 83 degrees. More preferably this angle is measured to be in range of from about 79 degrees to 81 degrees.

In one embodiment of the invention the body portion of the bladelike member is of unitary construction. In another embodiment of the invention, the body portion defines one or more notches for aiding in removal of cuttings.

Another embodiment of the invention provides a kit for removing a section of an inner pipe from a bore of an outer pipe, useable in combination with a rotational driver, which kit comprises a plurality of planing apparatuses wherein each apparatus comprises: A) an elongated bladelike member having a thickness, a width and a length, which bladelike member is symmetrical about an imaginary central longitudinal axis, and which bladelike member comprises (i) a shoulder portion comprised of two beveled cutting areas and (ii) a body portion forming a leading edge which is convex relative to the body portion; and B) an elongated shank member for coupling the planing apparatus to the rotational driver, which shank member is attached to and axially aligned with the shoulder portion of the bladelike member.

Yet another embodiment of the invention provides a method for removing a section of an inner pipe from a bore of an outer pipe, which method comprises:
I) aligning a planing apparatus with an aperture of the inner pipe, which planing apparatus is operatively coupled to a rotational driver, and which planing apparatus comprises A) an elongated bladelike member having a thickness, a width and a length, which bladelike member is symmetrical about an imaginary central longitudinal axis, and which bladelike member comprises (i) a shoulder portion comprised of two beveled cutting areas and (ii) a body portion forming a leading edge which is convex relative to the body portion; and B) an elongated shank member for coupling the planing apparatus to the rotational driver, which shank member is attached to and axially aligned with the shoulder portion of the bladelike member;
II) activating the rotational driver to cause the cutting areas to plane away the section of the inner pipe as the cutting areas come into contact with one or more surfaces of the inner pipe;
III) guiding the planing apparatus into the inner pipe a sufficient distance to plane away a suitable section of the inner pipe; and
IV) removing the planing apparatus from the bore of the outer pipe.

The various embodiments and features of this invention will now become apparent from the following detailed description, the accompanying drawings and the appended claims.

### SUMMARY OF THE FIGURES

FIG. 1 is a top view of one embodiment of this invention adjacent to a phantom view of sections of pipe.

FIG. 2 is a side view in perspective of an embodiment of the invention.

FIG. 3 is a side view of an embodiment of the invention.

FIG. 4 is a rear view of an embodiment of the invention.

FIG. 5 is a top view of an embodiment of this invention.

Like numbers and/or letters in the various figures are used to refer to like parts or components within the group of figures.

### DETAILED DESCRIPTION OF THE INVENTION

As will now be appreciated, the present invention makes possible planing or reaming sections of “plastic” pipe such as PVC, CPVC and HPVC pipe which as been glued or cemented into a bore of another section of pipe or into a bore of a fitting. The cutting away of the unwanted pipe can be accomplished in an easy operation by use of an embodiment of an apparatus of this invention which quickly attaches to a conventional rotational driver such as a hand-held portable drill. An embodiment of the invention provides an apparatus for reaming out or planing away a piece of plastic pipe fixed in a plastic pipe fitting so that the plastic pipe can be replaced without damaging the fitting.

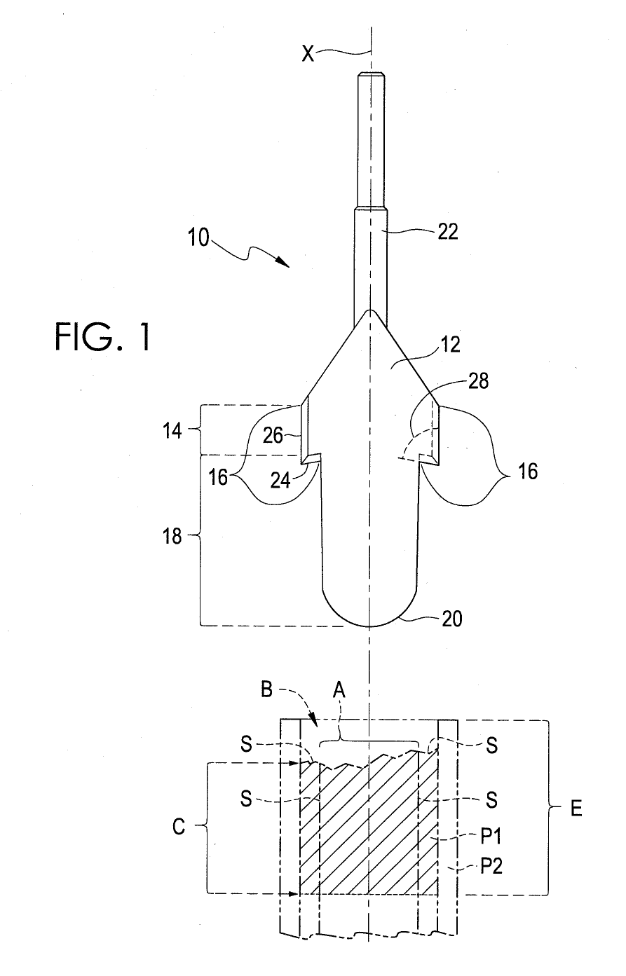

Referring now to the accompanying figures, FIG. 1 illustrates a planing apparatus 10 which is shown to comprise an elongated bladelike member 12. Bladelike member 12 is symmetrical about an imaginary central longitudinal axis X and comprises a shoulder portion 14 which comprises two beveled cutting areas 16,16 and a body portion 18 which forms a leading edge 20. Leading edge 20 is convex relative to body portion 18. The convex shape of leading edge 20 serves as an aid for guiding planing apparatus 10 into an aperture of a section of plastic pipe which needs to be removed or partially pared down from its location inside another section of pipe or inside a pipe fitting. Planing apparatus 10 is shown to comprise an elongated shank member 22 which is sized and configured for coupling planing apparatus 10 to a rotational driver D (not shown). The outer circumference of shank member 22 can be dimensioned to provide a snug rotatable fit with a rotational driver such as a portable electric drill. Shank member 22 is sized and configured to have either cylindrical shape or hexagonal shape for use with differing rotational drivers. A preferred embodiment of the invention provides that planing apparatus 10 have a unitary construction for ease of manufacture.

As shown in FIG. 1, cutting area 16 is comprised of two cutting edges. First cutting edge 24 and second cutting edge 26 converge to form an angle of incidence 28 which measures in the range of about 77 degrees to about 83 degrees, and more preferably in the range of about 79 degrees to about 81 degrees. By the term beveled, it is to be understood that the cutting areas are made up of cutting edges that are pitched at angles that provide precise planing capabilities without gouging or jamming into the relatively soft plastic material of the pipe. The pitches of the bevels of the respective first cutting edge and second cutting edge can be equal or unequal, that is, the two cutting edges can have pitches of the same degree or of different degrees. As can be seen in FIG. 1, the bevel of cutting areas 16,16 are disposed on opposing faces of opposing sides of shoulder portion 14 so as to most efficiently cut into the surface S of inner pipe P1.

Inner pipe P1 can be seen to be lodged inside bore B of outer pipe P2. Planing apparatus 10, after being operably attached to rotational driver D, not shown, will be guided into aperture A to a distance E to allow rotational motion of cutting areas 16,16 to shave or plane away a portion C of inner pipe P1 which is to be removed. It is to be understood that outer pipe P2 could easily be a fitting or other coupling, rather than a section of pipe. Most, though not all, shavings or cuttings produced by the operation of the planing apparatus will be pushed ahead of the planing apparatus and can be readily removed when the planing apparatus is withdrawn from the bore of the outer pipe.

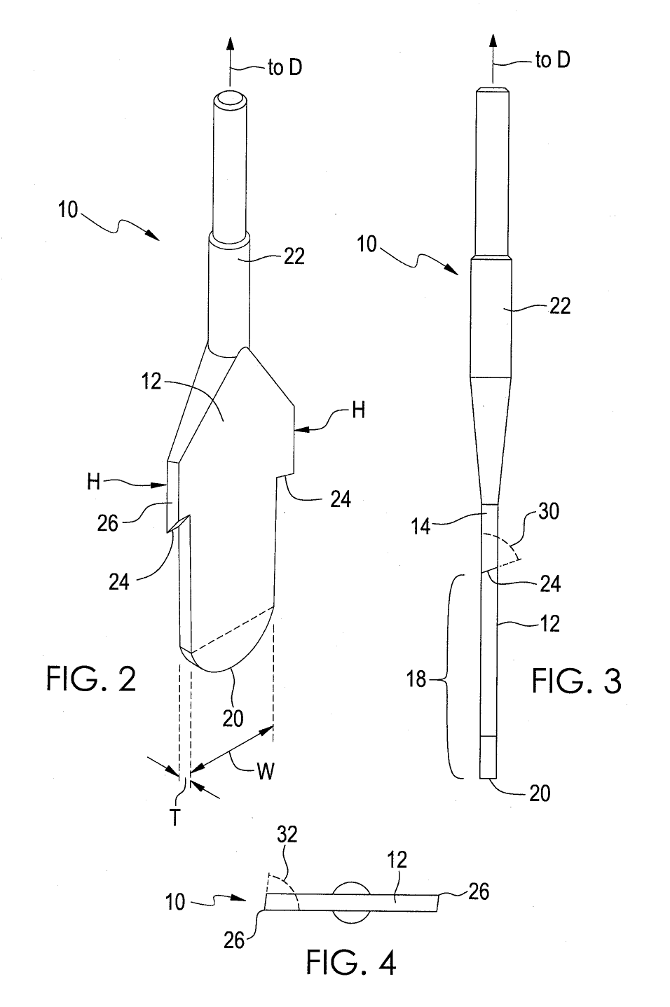

FIG. 2 further illustrates an embodiment of planing apparatus 10 where side H of shoulder portion 14 is shown to be the location of cutting areas 16,16. Planing apparatus is shown to have dimensions of thickness T, width W and length L. Variation in these dimensions results in a plurality of planing apparatuses, provided, for instance in a kit, which can be used with multiple different pipe diameters.

Aperture A of inner pipe P1 is seen in FIG. 1. Surfaces S,S of inner pipe P1 are contacted by cutting areas 16,16 of planing apparatus 10 when the rotating planing apparatus is guided into aperture A. Distance C represents the length of inner pipe P1 which will be planed away and removed.

FIG. 3 depicts a side view of planing apparatus 10 which shows the pitch 30 of first cutting edge 24. Pitch 30, or angle of bevel, is in the range of about 85 degrees to about 89 degrees, and preferably in the range of about 86.5 degrees to about 87.5 degrees.

FIG. 4 illustrates an embodiment of the invention as viewed from the rear. Planing apparatus 10 can be seen to have second cutting edge 26 with a pitch 32, or angle of bevel, shown to be in the range of about 85 degrees to about 89 degrees, and preferably in the range of about 86.5 degrees to about 87.5 degrees. It has been found, surprisingly, that providing slightly different pitches for the first and second cutting edges greatly improves the operation of the planing apparatus and prevents gouging and jamming.

The angles of bevel or the pitches of the cutting edges make it possible to cleanly plane away PVC pipe having a thickness of, at least, from schedule 20 to schedule 40 PVC pipe without jamming or gouging the inner pipe. A schedule of pipe refers to a pipe sizing system for the outside diameter and wall thickness dimensions of the pipe.

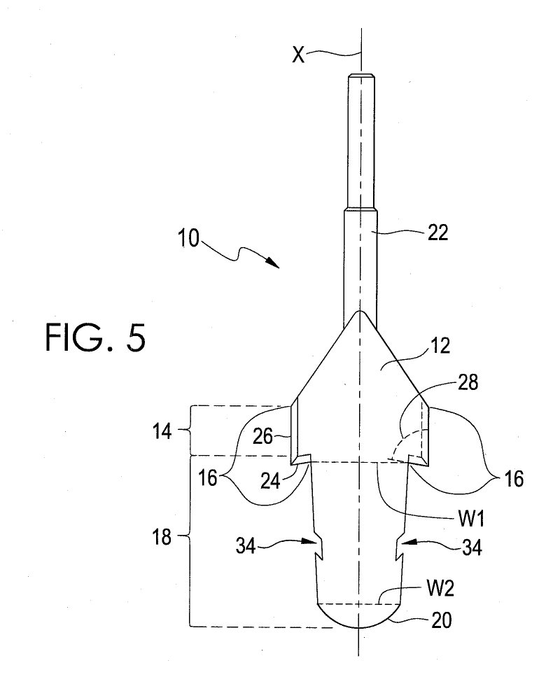

FIG. 5 shows an embodiment of the invention wherein body portion 18 of planing apparatus 10 is shown to have sides configured to have a slight taper from shoulder portion 14 to leading edge 20 so that a first width W1 of body portion 18, measured at or near first cutting edge 24 is greater than a second width W2 of body portion 18, measured at or near the base of convex leading edge 20. Notches 34,34 are depicted as defined by the sides of body portion 18. Notches 34,34 are useful in snagging and retaining shavings or cuttings of pipe material so that such shaved material is more easily extracted from the pipe at the finish of the planing process.

In an embodiment of the invention, a kit is provided which comprises a plurality of planing apparatuses in multiple different sizes. The dimensions L, W, and T of the planing apparatuses vary to provide a choice of dimension of planing apparatus for use with a variety of different diameter pipes or fittings.

In a situation where the planing apparatus is to be used for removing a section of an inner pipe form a bore of an outer pipe, the inner pipe will typically have broken leaving an uneven end within the outer pipe. The outer pipe can also be a pipe fitting which could be reused if the broken pipe could be remove without damaging the fitting. The user will choose the particular planing apparatus to suit the dimensions of the interior diameter of the inner pipe, usually in the range of 0.5 inch to 1.25 inch. After attaching the planing apparatus to a portable drill or other rotational driver at the shank member and tightening the operable connection according to the standard methods of the drill, the user will activate the drill so that the planing member rotates at an appropriate rpm depending on the drill type and specification. If the inner pipe is to be removed from a fitting, the fitting, with inner pipe attached, can first be secured in some manner for ease of maneuvering, such as being secured in a vice. Appropriate personal protective equipment should be employed, such as safety goggles and gloves for the user.

The rotating planing apparatus is aligned with the aperture of the inner pipe and, as the planing apparatus is guided into the inner pipe, the cutting areas will begin to plane away the material making up the inner pipe. Shavings may fall either in or out of the pipes. It is to be understood that the alignment of the planing apparatus with the aperture of the inner pipe can be accomplished either before or after the rotational driver or drill is activated. The sequence of these two steps can be reversed and still be within the scope of this invention.

The user will guide the planing apparatus into the inner pipe for a sufficient distance to plane away and remove a suitable section of the inner pipe. By suitable section, it is to be understood that in some instances all traces of the inner pipe will not need to be removed. For instance, it could be that only enough material of the inner pipe needs to be removed to allow attachment of a new section of PVC pipe or a new PVC fitting, leaving some material from the inner pipe within the outer pipe.

After a desired amount of inner pipe material is shaved or planed away, the planing apparatus is removed from the bore of the outer pipe, leaving the outer pipe intact and structurally sound.

Suitable materials of construction of the planing apparatus include, but are not limited to, metal such as carbon steel and stainless steel.

Except as may be expressly otherwise indicated, the article “a” or “an” if and as used herein is not intended to limit, and should not be construed as limiting, a claim to a single element to which the article refers. Rather, the article “a” or “an” if and as used herein is intended to cover one or more such elements, unless the text expressly indicates otherwise.

This invention is susceptible to considerable variation in its practice. Therefore the foregoing description is not intended to limit, and should not be construed as limiting, the invention to the particular exemplifications presented hereinabove.

It should be appreciated that, while specific embodiments are described hereinafter, several other applications of the presently described invention may be contemplated by those of skill in the art in view of this disclosure. Accordingly, the scope of this invention is not limited to the specific embodiments described in detail hereinafter. Rather, what is intended to be covered is as set forth in the ensuing claims and the equivalents thereof permitted as a matter of law.

1. A planing apparatus comprising:
A) an elongated bladelike member having a thickness, a width and a length, which bladelike member is symmetrical about an imaginary central longitudinal axis, and which bladelike member comprises (i) a shoulder portion comprised of two beveled cutting areas and (ii) a body portion forming a leading edge which is convex relative to the body portion; and
B) an elongated shank member for coupling the planing apparatus to a rotational driver, which shank member is attached to and axially aligned with the shoulder portion of the bladelike member.

2. An apparatus as in claim 1 wherein each of the beveled cutting areas comprises two cutting edges which converge.

3. An apparatus as in claim 2 wherein the two cutting edges converge to form an acute angle.

4. An apparatus as in claim 1 wherein the body portion is of unitary construction.

5. An apparatus as in claim 1 wherein the shoulder portion consists essentially of two beveled cutting areas disposed on opposing sides of the shoulder portion.

6. An apparatus as in claim 2 wherein the two cutting edges have pitches which are of different degree.

7. An apparatus as in claim 1 wherein the body portion defines on or more notches.

8. A kit for removing a section of an inner pipe from a bore of an outer pipe, useable in combination with a rotational driver, which kit comprises a plurality of planing apparatuses wherein each apparatus comprises: A) an elongated bladelike member having a thickness, a width and a length, which bladelike member is symmetrical about an imaginary central longitudinal axis, and which bladelike member comprises (i) a shoulder portion comprised of two beveled cutting areas and (ii) a body portion forming a leading edge which is convex relative to the body portion; and B) an elongated shank member for coupling the planing apparatus to the rotational driver, which shank member is attached to and axially aligned with the shoulder portion of the bladelike member.

9. A kit as in claim 8 wherein each of the beveled cutting areas comprises two cutting edges which converge.

10. A kit as in claim 9 wherein the two cutting edges converge to form an acute angle.

11. A kit as in claim 8 wherein the body portion is of unitary construction.

12. A kit as in claim 8 wherein the plurality of planing apparatuses are sized and configured to have multiple different external widths.

13. A kit as in claim 11 wherein the shoulder portion consists essentially of two beveled cutting areas disposed on opposing sides of the shoulder portion.

14. A kit as in claim 13 wherein each of the beveled cutting areas comprises two cutting edges which converge.

15. A kit as in claim 14 wherein the two cutting edges converge to form an acute angle.

16. A method for removing a section of an inner pipe from a bore of an outer pipe, which method comprises:
I) aligning a planing apparatus with an aperture of the inner pipe, which planing apparatus is operatively coupled to a rotational driver, and which planing apparatus comprises A) an elongated bladelike member having a thickness, a width and a length, which bladelike member is symmetrical about an imaginary central longitudinal axis, and which bladelike member comprises (i) a shoulder portion comprised of two beveled cutting areas and (ii) a body portion forming a leading edge which is convex relative to the body portion; and B) an elongated shank member for coupling the planing apparatus to the rotational driver, which shank member is attached to and axially aligned with the shoulder portion of the bladelike member;
II) activating the rotational driver to cause the cutting areas to plane away the section of the inner pipe as the cutting areas come into contact with one or more surfaces of the inner pipe;
III) guiding the planing apparatus into the inner pipe a sufficient distance to plane away a suitable section of the inner pipe; and
IV) removing the planing apparatus from the bore of the outer pipe.

17. A method as in claim 16 wherein each of the beveled cutting areas comprises two cutting edges which converge.

18. A method as in claim 17 wherein the two cutting edges converge to form an acute angle.

19. A method as in claim 16 wherein the body portion is of unitary construction.

20. A method as in claim 16 wherein the shoulder portion consists essentially of two beveled cutting areas disposed on opposing sides of the shoulder portion.
